(19) United States
(12) Patent Application Publication
(10) Pub. No.: US 2002/0148092 A1
(43) Pub. Date: Oct. 17, 2002

(54) Quick changing tool holder clamp for computer numeric control milling machine tool holders

(76) Inventor: Paul I Van Metre, Kenmore, WA (US)

Correspondence Address: JAMES R. VILLEGAS, P.O. BOX 273, BLAINE, WA, 98231, US

(21) Appl. No.: 09/681,496

(22) Filed: Apr. 17, 2001

(51) Int. Cl. B23P 11/02

(52) U.S. Cl. 29/450

(57) ABSTRACT

The Quickchange Tool Holder Clamp secures Computer Numeric Control milling machine tool holder shanks in a single action by locking the tool holder in a horizontal position through the application of tension on the shank's collar when the shank is placed in an aperture with contours that specifically match those of the shank's collar. Use of this device Secures the collar of the shank rather than the body of the shank, minimizing handling of the shank and tool and thereby protecting the shank, the tool and the human operator from damage while allowing for rapid and safe accessibility to all sides of the tool and its components.

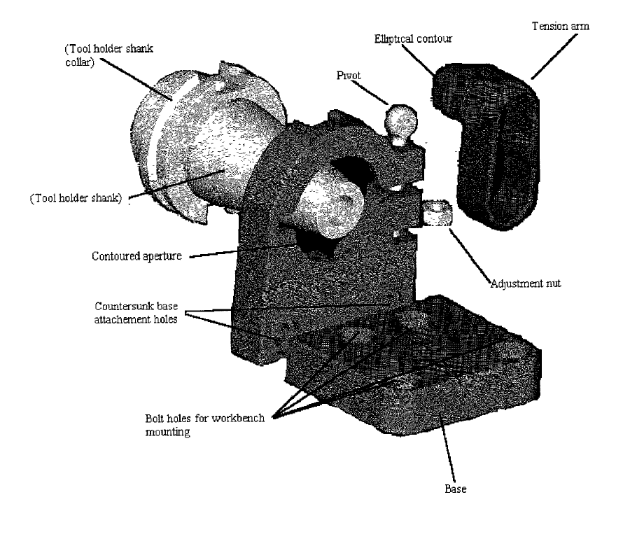

### BACKGROUND OF INVENTION

Computer Numerical Control (CNC) milling machines fabricate metal with a cutting tool held in position by a cutting tool holder shank. It is often necessary to maintain or remove the cutting tool and the generally accepted means to do this is to leave the tool attached to the shank and remove the shank from the CNC mill, whereupon the tool holder shank is secured in a clamp or vice. The tool holder clamp needs to be simple to operate and must secure the tool holder shank in such a way as to not damage it, yet provide complete access to the cutting tool itself and safety in regards to the equipment and human operator.

### DETAILED DESCRIPTION

The Quickchange tool holder clamp is comprised of anodized aluminum and consists of a workbench mountable base, a perpendicular tool holder with a contoured aperture that is gaped on the left side, a side mounted handle that is bolted to a pivot, said pivot passing through the aperture gap and secured with a nylock style adjustment nut. The perpendicular sidepiece is attached to the base with two counter sunk bolts.

The tool holder aperture is designed to fit the specific contours of the tool holder shank collars of certain sized tool holders. The shank is inserted through the aperture and the shank collar is made stationary when the collar's contours fit into the matching contours of the aperture and tension is applied to the tool holder shank collar by raising the tension handle. The elliptical contour shape of the tension handle top marrying the shape of the perpendicular tool holder creates tension sufficient enough to lock the tool holder shank's collar into place, thus securing the tool holder in a horizontal position suitable for tool maintenance.

1. A method of securing CNC milling tool holder shanks to a work bench in a horizontal position by applying torsion to the collar only of the tool holder shank by means of a tension.

2. A method according to claim 1 wherein the tool holder collar is locked in a horizontal position by its placement in an aperture specifically designed for the collar and size of that specific tool holder's contours.

3. A method according to claim 1 by which the tool holder can be rapidly placed, rapidly secured, and rapidly removed by raising or lowering a single handle in each case.

4. A method according to claim 2 where by the tool holder is locked in place in such a way as to prevent slippage of the tool holder shank, thereby removing a variable for physical harm to the human operator, the tool holder shank and to the tool itself.
